(19) United States
(12) Patent Application Publication
(10) Pub. No.: US 2008/0096592 A1
(43) Pub. Date: Apr. 24, 2008

(54) Systems and Methods for Providing Communications Services Using Assigned Codes

(76) Inventors: William L. Waytena, San Francisco, CA (US); Eric T. Stone, San Francisco, CA (US)

Correspondence Address: GORDON & JACOBSON, P.C., 60 LONG RIDGE ROAD, SUITE 407, STAMFORD, CT, 06902, US

(21) Appl. No.: 11/741,196

(22) Filed: Apr. 27, 2007

Related U.S. Application Data
(63) Continuation-in-part of application No. 11/680,291, filed on Feb. 28, 2007.
Application No. 11/680,291 is a continuation-in-part of application No. 11/550,837, filed on Oct. 19, 2006.

(51) Int. Cl. H04M 1/00; H04Q 7/20

(52) U.S. Cl. 455/466; 455/550.1

(57) ABSTRACT

A communications service (and components thereof) have one or more communication addresses (e.g. short codes, telephone numbers, IM names/domains, IP addresses, etc.) for receiving text-based messages, a service platform for carry out a number of telecommunication services, and a database of registered subscribers. Subscribers access the database preferably through a web-enabled interface. A subscriber is associated with a unique alphanumeric code. This code is conveyed to other individuals as desired. The individual enters the alphanumeric code as part of a text-based message communicated to the communications address of the service. The unique subscriber codes are extracted from the message and used to carry out a communication service pertaining to the subscriber associated therewith. In the preferred embodiment, the communication service can be any one or a number of services dictated by a command type included in the message.

According to another aspect of the invention, unique codes are associated with content items stored (or referred to) by subscribers of the system. Such content items can be voicemail messages, audio status messages, and/or media content. A unique code is conveyed to other individuals as desired. The individual enters the code as part of a text-based message communicated to the communications address of the service. The unique code is extracted from the message and used to carry out a communication service pertaining to the content item associated therewith. In the preferred embodiment, the unique codes for content items comprise two-part codes as described herein.

### CROSS-REFERENCE TO RELATED APPLICATIONS

This application is a continuation-in-part of Ser. No. 11/680,291, filed Feb. 28, 2007, and entitled “Method and System for Centralized Storage of Media and for Communication of Such Media Activated by Real-Time Messaging”, the complete disclosure of which is incorporated by reference herein. This application is also a continuation-in-part of Ser. No. 11/550,837, filed Oct. 19, 2006, and entitled “Telecommunication System”, the complete disclosure of which is incorporated by reference herein.

### BACKGROUND OF THE INVENTION

1. Field of the Invention

This invention relates broadly to communications. More particularly, this invention relates to communication services that are initiated by text messaging or other messaging platforms.

2. State of the Art

Telephone devices such as traditional landline phones and mobile phones include a keypad or dialer that is operated by a user to initiate a conversation with one or more individuals. Mobile phones also typically employ a graphical user interface that allows the user to store and maintain a list of contacts and phone numbers associated therewith. The user interacts with the interface to identify a particular contact and then selectively initiate a conversation with the particularly contact.

Advanced cellular services introduced technology that assisted customers' needs for availability and receipt of instantaneous information. One such technology, known as Short Messaging Service (SMS), enables individuals to send and receive short text messages on mobile phones and other mobile devices (and occasionally even on computers). SMS was developed in Europe in the early 1990s. Initially, SMS was available as part of GSM networks; however, it is now available on a wide range of networks, including CDMA and 3G networks. SMS is a point-to-point communication method whereby an SMS message is transmitted from a wireless phone (or other mobile device or possibly a computer) to a short message service center (SMS-C), which acts as a store and forward system for short messages. The message is forwarded from the SMS-C to the destination phone (or other mobile device or possibly a computer).

The previously incorporated U.S. applications describe new advantageous communications services which can be accessed in a variety of ways. It is the inventors' goal to expand these services in other new and useful ways. In particular, it would be useful to allow people to contact you without revealing your true contact information. For example, if someone wants to be reachable by phone (or email or IM or text message) for a short period of time but not after that period of time, one would ordinarily need to change phone numbers, email addresses, etc. A situation in which this might arise is an online auction or selling something by classified advertisement. When the sale is concluded, it would be desirable to disable the phone number, email or other contact information that was used during the sale. Conversely, some people may find that they need to frequently change contact information but they want all of their contacts to know the new contact information. It would be desirable to effectively forward messages directed to old contact addresses and phone numbers to the new contact addresses and phone numbers, thereby relieving the need to notify all of one's contacts of the new contact information and relieving one's contacts from the need to update their contact lists.

### SUMMARY OF THE INVENTION

It is therefore an object of the invention to provide systems and methods for triggering or enabling the transfer of information over a communications network.

It is another object of the invention to provide systems and methods for using assigned codes to trigger or enable the transfer of information over a communications network.

It is a further object of the invention to provide systems and methods for assigning codes to individuals or media files for use in communications services.

In accord with these objects, which will be discussed in detail below, the systems and methods of the invention include a service provider having one or more communication addresses (e.g. short codes, telephone numbers, IM names/domains, IP addresses, etc.) for receiving text-based messages, a service platform for carrying out one or more communication services, and a database of registered subscribers. Subscribers access the database preferably through a web-enabled interface.

A subscriber is associated with a unique alphanumeric code. This code is conveyed to other individuals as desired. The individual enters the alphanumeric code as part of a text-based message communicated to the communications address of the service. The unique subscriber code is extracted from the message and is used to carry out a communication service pertaining to the subscriber associated with the received subscriber code. In the preferred embodiment, the communication service can be any one or a number of services dictated by a command type included in the message.

According to another aspect of the invention, unique codes are associated with content items stored (or referred to) by subscribers of the system. Such content items can be voicemail messages, audio status messages, and/or media content. A unique code is conveyed to other individuals as desired. The individual enters the code as part of a text-based message communicated to the communications address of the service. The unique code is extracted from the message and used to carry out a communication service pertaining to the content item associated therewith. In the preferred embodiment, the unique codes for content items comprise two-part codes as described herein.

In the preferred embodiment of the invention, the plurality of communications services supported by the service platform of the present invention include at least one of voice call functions, voice mail functions, text message functions, text broadcast functions, and media delivery functions.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of an embodiment of a communication system in accordance with the present invention; and

FIG. 2 is an illustrative screen shot of a portion of a user interface according to the invention.

FIG. 3 is an illustrative screen shot of a portion of another user interface according to the invention.

### DETAILED DESCRIPTION

As used herein, the term “telecommunication” is generally defined as the transmission and reception of signals over a distance for the purpose of communication. A “telephony device” (or “telephony terminal” or “telephone”) is generally defined as a communications device which is used to transmit and receive sound (most commonly voice and speech) across distance. A “communications device” (or “communications terminal”) is a device that transmits and receives signals for the purpose of communication.

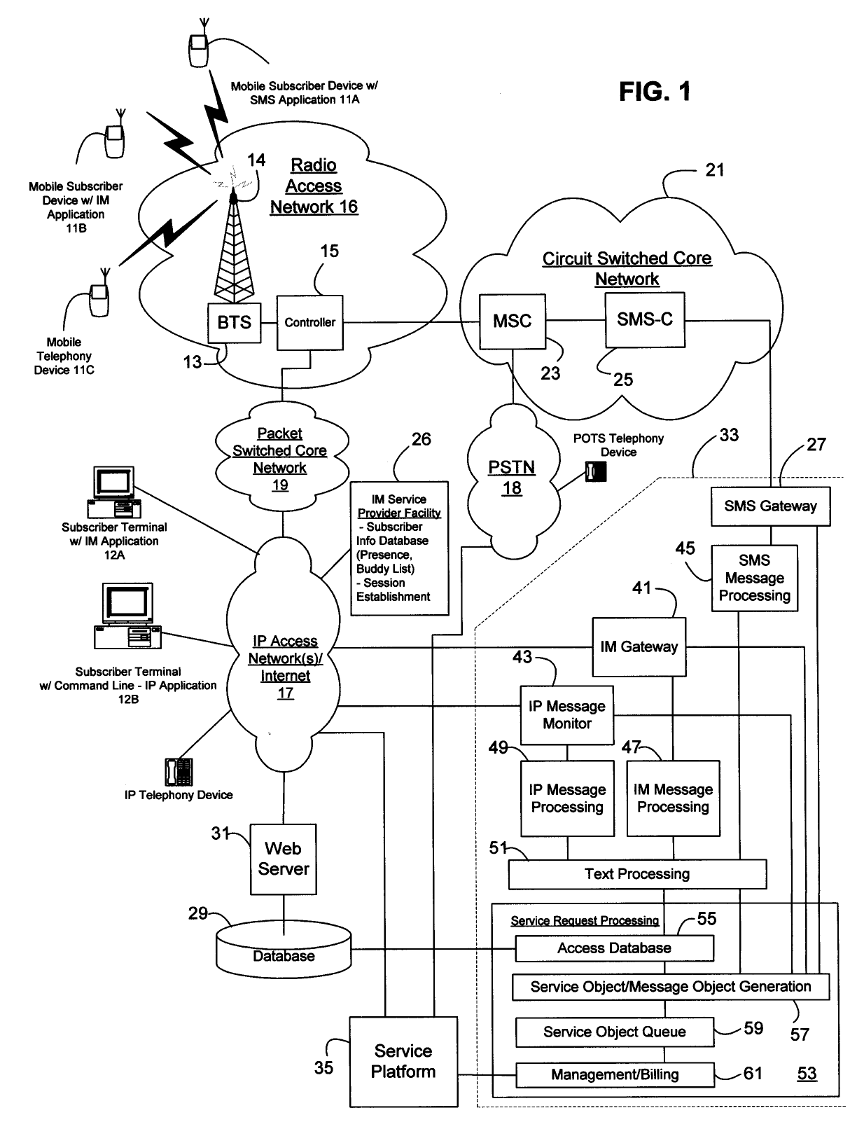

Turning now to FIG. 1, there is shown a schematic diagram of an exemplary communication system in which the present invention may be embodied. Mobile telephony devices 11A-11C communicate over wireless communication links to a mobile access network 16, which includes a plurality of base stations 13 (one shown) that are operably coupled to controllers 15 (one shown). The controllers 15 are responsible for radio resource allocation to the mobile telephony devices 11A-11C, and for frequency administration and handover between base stations 13. The controller function may be physically located within a base station 13 itself. Each base station 13 includes at least one antenna 14 and a group of one or more radio transmitter-receiver pairs (not shown). Each transmitter-receiver pair operates on a pair of radio frequencies to create a communication channel: one frequency to transmit radio signals to a mobile telephony device 11 and the other frequency to receive radio signals from the mobile telephony device 11. Each base station 13 defines a cell of the mobile access network 16, which is a predetermined volume of space radially arranged around its antenna 14. In order to prevent the radio signals transmitted from one base station from interfering with radio signals transmitted from an adjacent base station, the transmitter frequencies for adjacent base stations are selected to be different so that there is sufficient frequency separation between adjacent transmitter frequencies. In order to reuse the same frequencies, the cellular telecommunication industry has developed a small but finite number of transmitter frequencies and allocation patterns that ensure that adjacent cell sites do not operate on the same frequency. When a mobile telephony device 11 initiates a call connection, control signals transmitted from the local base station 13 cause the frequency agile transponder in the mobile telephony device 11 to operate at the frequency of operation designated for that particular base station. As the mobile telephony device 11 moves from one cell to another, the call connection is handed off to the successive base station and the frequency agile transponder in the mobile telephony device 11 adjusts its frequency of operation to correspond to the frequency of operation of the base station 13 located in the cell in which the mobile telephony device 11 is presently operational.

Fixed or mobile communication terminals 12A, 12B communicate over communication links to the IP access network(s)/Internet 17 as is well known. Such communication can be carried out by a cable modem coupled to a hybrid fiber coax data network, a DSL modem coupled to a DSL access network, or a radio interface coupled to a Wi-Fi or Wi-Max access network. The fixed or mobile communication terminals 12A, 12B can be any of a number of communication devices including personal computers, laptop computers, personal digital assistants, networked kiosks, VOIP phones, traditional phones connected to VOIP gateways, and the like.

The mobile access network 16 interfaces to a packet switched core network 19 and to a circuit switched core network 21. Packet switched traffic (e.g., IP packet data) that originates from (or is destined to) the mobile telephony devices 11A-11C is routed over the packet switched core network 19. Circuit switched traffic (e.g., voice calls, SMS messages) that originates from (or is destined to) the mobile telephony devices 11A-11C is routed over the circuit switched core network 21.

The packet switched core network 19 connects to the Internet 17 and includes functionality for data session management of the mobile telephony devices 11A-11C and for routing packet switched traffic into and out of the packet switched core network 19. In this manner, the packet switched core network enables the mobile telephony devices 11A-11C to connect to Internet-connected devices (e.g., a web server, a VOIP communication terminal, etc.) as needed.

The circuit switched core network 21 includes a mobile switching center (MSC) 23 and an SMS center (SMS-C) 25. Generally, the MSC 23 connects the circuit switched core network 21 to the public switched telephone network 18 and manages and routes circuit switched voice traffic into and out of the circuit switched core network 21. In this manner, the MSC 23 enables the mobile telephony devices 11 to connect to POTS telephony devices that interface to the PSTN 18 as needed.

The SMS-C 25 functions as a centralized store-and-forward device that accepts SMS messages and buffers the received SMS messages until a suitable delivery time (e.g., the destination mobile telephony device 11A is powered on and the location known). The SMS-C 25 also provides an interface in accordance with a communication protocol (e.g., UCP, SMPP, Sema OIS, CIMD2) that allows for communication of SMS messages to and from other cell networks and to and from other external SMS processing devices (e.g., the SMS gateway 27). Preferably, the external SMS processing device(s) is (are) connected to the SMS-C 25 over a wide area network such as the Internet.

Numerous technologies, such as GSM, CDMA, EDGE and W-CDMA technology, can be used to implement the radio access network 16 and the supporting core networks 19 and 21. GSM technologies provide GPRS services which can be used for packet switched applications. 3G CDMA technologies provide code division multiple access technology for packet switched applications. EDGE technology provides enhanced GPRS services. High-speed data applications such as video services and other multimedia services benefit from the increased data capacity provided by the enhanced GPRS services. W-CDMA technology employs wideband code division multiplexing technology to provide high speed packet switched data rates that are suitable for high-speed data applications such as video services and other multimedia services.

The communication system of FIG. 1 supports a number of telecommunication services in response to messages conforming to diverse messaging formats. In the preferred embodiment, the diverse messaging formats include a Short Message Service (SMS) messaging format, an Instant Message (IM) messaging format, and a proprietary IP messaging format.

The SMS messaging format, which is specified by the ETSI organization (documents GSM 03.40 and GSM 03.38), can be up to 160 characters long, where each character is 7 bits according to the 7-bit default alphabet. An eight-bit message format (max 140 characters) can also be used, but this format is usually not viewable by the phones as text messages; instead it is used for data in smart messaging (images and ringing tones) and OTA provisioning of WAP settings. A 16-bit message format (max 70 characters) can also be used for Unicode (UCS2) text messages and is viewable by most phones. There are two ways of sending and receiving SMS messages: by a protocol description unit (PDU) mode or by a text mode. The PDU mode contains not only the text of the message, but also a lot of meta-information about the sender (e.g., the sender's SMS service center, the time stamp, etc). The text mode is just an encoding of the bit stream represented by the PDU mode. Alphabets may differ and there are several encoding alternatives when displaying an SMS message. The most common options are “PCCP437”, “PCDN”, “8859-1”, “IRA” and “GSM”. These options are set by the at-command AT+CSCS. An application capable of reading incoming SMS messages can thus use text mode or PDU mode. If text mode is used, the application is bound to (or limited by) the set of preset encoding options. If PDU mode is used, any encoding can be implemented.

Instant messages are generated by applications for carrying out text conversations that are to happen in real-time. Instant message service providers (e.g., AOL Instant Messenger, Yahoo! Messenger, Skype, Google Talk, Windows Messenger, ICQ, etc.) typically maintain a facility 26 that includes a database storing a list of contacts for each subscriber and presence information. The presence information indicates the availability of the contacts. Most instant messaging service providers allow users to set and update their presence information so that peers get notified whenever the user is available, busy, or away. The facility 26 also includes logic that establishes communication sessions between subscribers (or between a subscriber and a user of another provider). The facility 26 typically employs proprietary protocols for maintaining presence information and receiving notifications related thereto (for example, a notification when a user logs-in or comes back from lunch), for managing a session of real-time messages between two or more participants, and for communicating such real time messages between the two or more participants of a given session. The message format for the real-time messages communicated between the participants of a given session is typically proprietary in nature and thus can vary between service providers. Standards-based protocols for instant messaging, such as XMPP and Jingle (defined at http://www.xmpp.org/extensions/xep-0166.html) can also be used.

Subscribers of the service access a database 29. Each subscriber can have the following information associated therewith in the database 29:
the user name of the subscriber;
a password and possibly other information for authentication of the subscriber;
at least one phone number for the subscriber, which can the number assigned to the subscriber's traditional POTS telephony device for home or business purposes, a number assigned to the subscriber's mobile telephony device, an identifier assigned to the subscriber's IP telephony device, or other identifier that is used to establish a voice connection to the subscriber;
at least one IM screen name/IM Service Provider for the subscriber, which is used to route IM messages and possibly for establishing a voice connection to the subscriber;
at least one email address for the subscriber;
a home address for the subscriber; and
a business address for the subscriber.

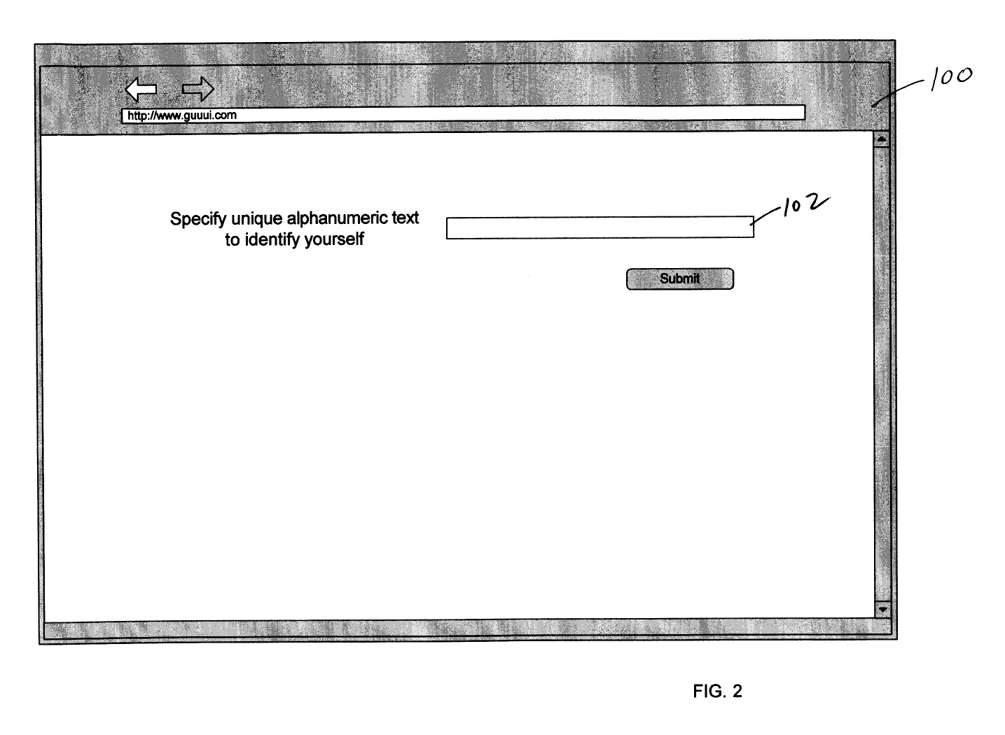

According to methods of the present invention which are described in more detail below with reference to FIG. 2, unique alphanumeric codes are associated with subscribers of the service. The unique alphanumeric codes (referred to below as “subscriber ID codes” or “subscriber ID code”) can be the user names assigned to subscribers or possibly other alphanumeric codes associated therewith. The subscriber ID codes are used to carry out telecommunication services by the system. The subscriber ID code for a given subscriber is unique to that given subscriber. The subscriber ID code may be automatically generated by the service provider or chosen by the subscriber in much the same was as a user name is chosen with conventional online services, i.e. via trial and error with the service provider appending numbers to the user chosen code to make it unique. The association between the subscriber ID code and the given subscriber is stored in the database 29.

Subscriber's access to the database 29 can be accomplished over the Internet with a web server (or application server) 31 that provides an interface therebetween. This configuration allows users to access and update the database 29 (and possibly manage other information) via user interaction with a web browser in communication with the web server (or application server) 31 over the Internet. The web browser can be executing on one of the Internet-connected fixed or mobile communication terminals 12A, 12B. Alternatively, it can be a micro-browser executing on one of the mobile telephony devices 11A-11C. In other embodiments, subscriber access to the database 29 can be realized by other communication means, such as messages directed to the service over any one of the diverse messaging formats supported by the service, interaction with an IVR system managed by the service, and/or other means.

A subscriber conveys his or her subscriber ID code to another individual. The subscriber can also convey the short telephone number or short code reserved for the service, the IM name/domain reserved for the service, or other identifier for the service. Such information can be conveyed verbally (for example, when meeting the party at a social gathering or as part of voice call), in a publication either printed or electronic (such as a bulletin board, online forum, classified ads, auctions, etc.), or in an electronic message (such as an email, SMS message or IM message). The individual enters the subscriber ID code as part of a text-based message that is sent to the service. This message (which is referred to below as a Service Request message) is communicated from a user-operated communication device, which can be one of the mobile telephony devices 11 or one of the fixed or mobile communication terminals 12. The Service Request message encapsulates plain text that includes the subscriber ID code uniquely assigned to a given subscriber of the service. The individual that generated the Service Request message (who is referred to below as the “requester”) is identified from data that is communicated as part of the Service Request message. For an SMS-type Service Request message, such data can include the ANI of the mobile telephony device that originated the SMS-type Service Request message. For an IM-type Service Request message, such data can include the IM screen name/IM Service Provider of the IM-type Service Request message. For a proprietary-IP-type Service Request Message, such data can include the source IP address of the proprietary-IP-type Service Request message.

In the preferred embodiment, the Service Request message communicated to the service encapsulates plain text with a command syntax as follows:

<command><subscriber ID code> . . .

The “<command>” field is text that identifies the message as a particular command that is supported by the service platform 35. In the preferred embodiment, the service platform 35 is capable of carrying out a number of diverse communication services which are assigned corresponding command types, such a “call” command, “text” or “IM” command, “grouptext” or “groupIM” command, “voicemail” command, “play” command, “record status” command, “follow” command, and “ishare” command as described below in more detail. The <subscriber ID code> field is an alphanumeric code that is uniquely assigned to a subscriber of the service as described herein. Note that the Service Request message can possibly have additional text fields as described below.

In the illustrative embodiment of the invention, the logic 33 includes an SMS gateway 27 for receiving (and possibly sending) SMS messages in accordance with one or more SMS messaging formats, an IM gateway 41 for receiving (and possibly sending) IM messages in accordance with one or more IM messaging formats, and an IP Message monitor 43 for receiving (and possibly sending) IP messages in accordance with one or more proprietary IP messaging formats.

The SMS Gateway 27 receives incoming SMS messages that are addressed to a reserved telephone number (or reserved short code) for the service and sends outgoing SMS from the reserved telephone number (or reserved short code) of the service. The SMS gateway 27 interfaces to the SMS-C 25 preferably using a communication protocol such as UCP, SMPP, Sema OIS, or CIMD2 that allows for the communication of SMS messages therebetween. The SMS gateway 27 interfaces to an SMS Message Processing block 45 that processes each given incoming SMS message received at the SMS Gateway 27 to extract the text data encapsulated in the given SMS message and passes the extracted text data of to a text processing block 51.

The IM Gateway 41 receives incoming IM messages that are addressed to one or more reserved IM user names for the service. The IM messages can also specify corresponding IM service providers. For example kadoink@gmail.com can be used to identify the reserved IM user name “kaDoink” for the service on the Google Talk IM Service. The IM Gateway 41 also sends outgoing IM messages addressed from such reserved IM user name(s) and service provider(s) if need be. The IM Gateway 41 interfaces to one or more IM Service Provider facilities 26 (e.g., facilities for AOL Instant Messenger, Yahoo! Messenger, Skype, Google Talk, Windows Messenger, ICQ, etc.) to maintain presence information as well as for session establishment for sending/receiving messages to/from subscribers of the one or more facilities 26. Such communication can employ proprietary protocols and/or standardized protocols such as XMPP and Jingle as discussed above. The IM Gateway 41 can carry out protocol translation to allow for interoperability between different IM messaging formats and platforms, if need be. The IM Gateway 41 interfaces to an IM Message Processing block 47 that processes each given incoming IM message received at the IM Gateway 41 to extract the text data encapsulated in the given IM message and pass the extracted text data to the text processing block 51.

The IP Message Monitor 43 receives incoming IP messages that routed to a predetermined IP address and port, and can also send outgoing IP messages that are routed to a predetermined IP address and port. The IP messages can use TCP or UDP packets as a transport mechanism. The message format for the incoming and outgoing IP messages can be proprietary in nature and known only by the two end points. The IP Message Monitor 43 interfaces to an IP Message Processing block 49 that processes each given IP message received at the IP Message Monitor 43 to extract the text data encapsulated in the given IP message and passes the extracted text data to the text processing block 51.

The text processing block 51 analyzes the text data of the message to extract the particular command and the particular subscriber ID code therein. The Request Processing block 53 includes block 55 that accesses the database 29 to identify the subscriber that is uniquely associated with the particular subscriber ID code extracted by block 51 as part of a given Service Request message. Information pertaining to the particular command and the particular subscriber identified by block 55 is output to block 57.

Block 57 generates a service object that specifies the information needed to carryout the telecommunication service specified by the command identified in block 55, and adds this object to the Object Queue 59.

The Object Queue 59 is a queue of Objects that is preferably processed on a FIFO basis. When selected from the queue, the object is passed to Management Processing block 61, which cooperates with the service platform 35 and/or one or more of the networks 16-19, 21 to deliver the telecommunication service dictated by the object and preferably bills the subscriber's account for the service.

Block 57 can also cooperate with the SMS Gateway 27 to generate and send an SMS message or to receive one. Block 57 can also cooperate with the IM Gateway 41 to generate and send or receive IM messages. Block 57 can also cooperate with the IP Message Monitor 43 to generate and send or receive IP messages.

In the event that an error occurs in the processing of a given service request message (for example, the subscriber ID code therein does not match any entry in the database 29), block 57 (or the other elements of the processing logic 33) can cooperate with the SMS Gateway 27 to generate and send one or more SMS messages that provide an indication of the error. Block 57 (or the other elements of the processing logic 33) can also cooperate with the IM Gateway 41 to generate and send one or more IM messages that provide an indication of the error. Block 57 (or the other elements of the processing logic 33) can also cooperate with the IP Message Monitor 43 to generate and send one or more IP messages that provide an indication of the error.

As stated above, according to the methods of the invention, unique subscriber ID codes are associated with subscribers of the service and used to carry out communication services to the subscribers. These services are associated with a number of command types, such as a “call” command, “text” or “IM” command, “grouptext” or “groupIM” command, “voicemail” command, “play” command, “record status” command, “follow” command, and an “ishare” command as described below in more detail.

Turning now to FIG. 2, according to an illustrative embodiment of the invention, a graphical user interface (GUI) 100 is provided whereby a subscriber ID code is assigned to a particular subscriber. The GUI may be accessed via any communications device which has a graphical display, a pointing device such as a mouse, trackball or stylus, and means for inputting alphanumeric text. Such devices include computers, smart mobile telephones and other wireless devices. Alternatively, a non-GUI connection can be provided. Such interactive connections include IVR with voice recognition or IVR with DTMF input by the subscriber. Subscribers access the service in any conventional way such as by entering a web site. The GUI 100 of FIG. 2 may be selected from a plurality of other GUIs which provide other services.

As illustrated in FIG. 2, the GUI provides a text input field 102 that enables the subscriber to specify text for use as the subscriber ID code. A submit button 104 is provided to submit the specified text for communication to the service. The service checks the uniqueness of the specified text with respect to the subscriber ID codes associated with other subscribers of the service. If not unique, an error message can be communicated back to the subscriber and presented on the interface 100 such that the subscriber can update/modify the specified text for submission to the service. In this manner, trial and error can be used to specify the unique subscriber ID code for the subscriber.

### Call Command

For the “call” command, the service logic 33 accesses the database 29 to identify the telephone number (or other identifier) of the subscriber that is associated with the <subscriber ID code> of the Service Request message. The service logic 33 controls the service platform 35 to connect to the ANI of the requestor that generated the Service Request message, to connect to the telephone number of the subscriber that is associated with the <subscriber id code>of the Service Request message (as dictated by the information stored in database 29), and then bridge the two connections together for voice communication therebetween (thus utilizing the service platform as an intermediary conference bridge). These operations are similar to those described in detail in U.S. application Ser. No. 11/550,837.

As part of the call set-up operations, the service logic 33 and service platform 35 can communicate with the subscriber over SMS (or possibly IM or other communication channels) to allow for call screening functionality. In the preferred embodiment, the subscriber is presented with a set of unique codes that allow the subscriber to invoke specific functions for the call (e.g., accept the call, block the call, direct the call to voicemail, send a text message to the requestor) related to the call. The subscriber sends a reply text-based message to the service with one of the unique codes therein. The logic 33 is adapted to wait for the reply message. In the event that the reply message includes the unique code for accepting the call, the service platform 35 provides for voice communication between the two parties as described above. In the event that the reply message includes the unique code for declining the call, the service platform 35 aborts the process for establishing voice communication between the two parties, if started, and possibly generates a message to the requesting party indicating the failure of the call. In the event that the reply message includes the unique code for directing the call to voice mail, the service logic 33 and service platform 35 connect the requestor to the voice mailbox of the subscriber as set forth below with respect to the “voicemail” command. Finally, in the event that the reply message includes the unique code for replying to the call request via a text message, the service logic 33 and service platform 35 forward the reply message to the requestor.

### Text Command

For the “text” command, the Service Request message includes additional text that is to be forwarded to the subscriber. The service logic 33 accesses the database 29 to identify the ANI of the subscriber that is associated with the <subscriber ID code> of the Service Request message. The service logic 33 controls the service platform 35 to generate and send an SMS-message to the ANI of the subscriber. This SMS message includes the additional text of the received Service Request message. In this manner, the service platform operates as a text message forwarding engine.

Similar operations can be used to carry out IM message forwarding in response to an “IM” command. For the “IM” command, the Service Request message includes additional text that is to be forwarded to the subscriber. The service logic 33 accesses the database 29 to identify the IM short name and IM service provider of the subscriber that is associated with the <subscriber ID code> of the Service Request message. The service logic 33 controls the service platform 35 to generate and send an IM message to the IM short name and IM service provider of the subscriber. This IM message includes the additional text of the received Service Request message. In this manner, the service platform operates as an IM forwarding engine.

### Group Text Command

For the “grouptext” command, the subscriber predefines a list of recipients. The recipients can be selected from contacts within the subscriber's contact list or by other means. The ANI of each recipient is specified or otherwise known. A short name or code is assigned to the list of recipients. These associations are stored in the database 29. When a subscriber makes these associations, the subscriber may then convey this shortname code to other individuals as desired.

For the “grouptext” command, the Service Request message includes the short name or code for the list of recipients as well as additional text that is to be forwarded to such recipient(s). The IM short name and IM service provider for each recipient is stored in the subscriber's contact list as part of the database 29. The service logic 33 accesses the database 29 to identify the IM short name and IM service provider of each recipient associated with the short name or code included as part of the Service Request message. It can also access the database 29 to identify the ANI of the subscriber that is associated with the <subscriber ID code> of the Service Request message. The service logic 33 controls the service platform 35 to generate and send an IM-message to the IM short name and IM service provider of each recipient (as dictated by the information stored in database 29). The IM-message can also possibly be communicated to the IM short name and IM service provider of the subscriber as well. This IM message includes the additional text from the received Service Request message. In this manner, the service platform operates as a group IM forwarding engine.

### Voicemail Command

For the “voicemail” command, the logic 33 accesses the database 29 to identify the subscriber that is uniquely associated with the <subscriber ID code> of the Service Request message. A voice mailbox for the subscriber is identified from system information. The service platform 35 connects to the ANI of the requestor and enables the requestor to leave voicemail in the mailbox of the subscriber (preferably through an IVR process as is conventional).

The subscriber can access his/her mailbox in any one of many different ways, such as call-in access, web-based access, text message access, IM access or other suitable access mechanism. The subscriber can also be presented with a variety of options regarding the voicemail message, such as forwarding the voicemail message, recording and sending a reply to the voicemail message, calling the originator of the voicemail message, etc.

In the preferred embodiment, the service logic 33 assigns a unique code to the voicemail message. The unique code can be used to refer to the voicemail message for subsequent operations carried out by the subscriber (e.g., forwarding the voicemail message, or recording and sending a reply to the voicemail message) as described below in more detail.

### Play Command

For the “play” command, the subscriber predefines media content (e.g., one or more audio files, video files or image files) to be delivered in conjunction with the “play” command. The media file may have been previously uploaded to subscriber space on a server or referenced by other means. A short name or code is assigned to the media content. These associations are stored in the database 29. When a subscriber makes these associations, the subscriber may then convey this short name or code to other individuals as desired. The Service Request message includes the short name or code for the designated media content. The service logic 33 accesses the database 29 to identify the subscriber that is associated with the <subscriber ID code> of the Service Request message as well as to identify the location of the media content associated with the short name or code included therein. The service platform 35 is controlled to connect to the telephone number (or other identifier) of the requestor. The media content referred to by the information in the database 29 is played (or possibly streamed) over the connection. These operations are similar to those described in detail in U.S. application Ser. No. 11/680,291.

### Record Status Command

The “record status” command supports the recording of audible status messages by subscribers of the service. For the “record status” command, the logic 33 accesses the database 29 to identify the ANI (or other identifier) of the subscriber that is uniquely associated with the <subscriber ID code> field of the Service Request message. The service platform 35 connects to the ANI of the subscriber and enables the subscriber to record an audible status message (preferably through an IVR process as is conventional). The subscriber can possibly be required to provide a password (or carry out other authentication operations) before recording the audible status message. The subscriber can also be presented with a variety of options regarding the audible status message (such as forwarding the audible status message to other subscribers, etc.). In the preferred embodiment, the service logic 33 assigns a code to the recorded audible status message. This code (which is referred to below as an <audio status object identifier>) together with the subscriber ID code assigned to the subscriber can be used to refer to the audible status message for subsequent operations carried out by the subscriber and/or other users, for example, the “Follow” command as described below in more detail. A subscriber can possibly update his/her recorded audible status message as needed by repeated invocation of the “record status” command. The subscriber can convey his/her ID code and the audio status object identifier code to other individuals as desired.

### Follow Command

The “follow” command supports the distribution of audible status messages recorded by subscribers of the service. For the “follow” command, the Service Request message includes a <subscriber ID code> field and an <audio status object identifier> field that together identify the audio status message recorded by a particular subscriber. When processing the “follow” command, the logic 33 accesses the database 29 to identify the audio status message specified by the <subscriber ID code> field and the <audio status object identifier> field of the Service Request message. The service platform 35 is controlled to connect to the telephone number (or other identifier) of the requester. The audio status message specified by the Service Request message is then played (or possibly streamed) over the connection. The logic 33 can also be adapted to monitor the audio status message specified by the Service Request message. In the event that this audio status message is updated, the service platform 35 can be adapted to automatically connect to the telephone number (or other identifier) of the requestor and the updated audio status message played (or possibly streamed) over the connection. Alternatively, in the event that the audio status message is updated, the service platform 35 can be adapted to automatically generate and send an email, SMS message, or IM message to the requestor providing notification of the updated audio status message. Preferably, this message includes a unique code that can be used by the requestor to access the updated audio status message via a text-based message directed to the service.

### Ishare Command

The “ishare” command supports the sharing of codes/tags maintained by the service. For the “ishare” command, the Service Request message includes an <ishare> field that designates the particular command, one or more <code> fields that identify the codes to share as part of the command, and a <subscriber ID code> field that identifies the recipient subscriber of the command. When processing the “ishare” command, the logic 33 accesses the database 29 to identify the codes specified by the <code> field(s) of the Service Request message and to identify the subscriber designated by the <subscriber ID code> of the Service Request message. The logic 33 then controls the service platform 35 to connect to the ANI of the requestor and enables the requestor to record an introductory voice message. The service platform 35 then communicates the code(s) specified by the <code> field(s) of the Service Request message and the introductory voice message recorded by the requestor to the subscriber designated by the <subscriber ID code> of the Service Request message. Such communication can be accomplished over email, SMS, IM, etc.

In order to illustrate the “ishare” command, consider an example where the service maintains a telecommunication service that is assigned a unique code “nytimes.updates”. This service provides news updates (in the form of podcasts or other audio content, video content, text messages, IM messages, etc) published by the New York Times Company. This code can be shared to a subscriber by issuing the following text message to the service: “ishare nytimes.updates with billyway” where “billyway” is the code uniquely assigned to a particular subscriber that will receive the shared code. The recipient subscriber can then access this particular service utilizing the code assigned to the service (for example, by issuing a “play” command as described above with the “nytimes.updates” code included therein).

In the preferred embodiment, when the introductory voice message is recorded for a particular code, the service logic 33 appends a system generated code to the code(s) specified by the <code> field of the Service Request message. This system generated code is associated with the introductory voice message recorded by the requestor. It is contemplated that more than one introductory voice message can be associated with a particular code as users pass the code around via the “ishare” command. In this case, the system generated code for the particular code can be incremented as each additional introductory voice message is associated with the particular code. For example, nytimes.updates.55 can reflect that there are 55 introductory voice messages associated with the media content code nytimes.updates. It is contemplated that a user can choose to hear (or ignore) the introductory voice messages associated with a particular code when the code is accessed.

### 2-Part Codes

As described above, the service assigns unique codes to voicemail messages recorded through processing of “voicemail” commands. In the preferred embodiment, the unique code assigned to a given voicemail message includes two parts with a predetermined delineator therebetween (e.g., <part1>.<part2> with the period as a delineator). The first part (e.g., <part1>) is a user ID code (e.g., subscriber ID code) designating the requestor that generated the voicemail message. The second part (e.g., <part2>) is a system generated code for the particular voicemail message. The two part code can be used to refer to the voicemail message for subsequent operations carried out by the subscriber. For example, the 2-part code can be forwarded to another user in an email, SMS message or IM message. The recipient user can then access the voicemail message utilizing the 2-part code, for example, by issuing a “play” command as described above with the 2-part code for the voicemail message included therein. Alternatively, the subscriber can interact with the system to record a reply to the recorded voicemail message. This recorded reply can be assigned a 2-part code and returned to the requestor that generated the voicemail message. In this case, the first part (e.g., <part1>) is the subscriber ID code designating the subscriber that generated the reply message. The second part (e.g., <part2>) is a system generated code for the particular reply message. The two part code can be used to refer to the reply message for subsequent operations carried out by the subscriber. For example, the 2-part code can be forwarded to another user in an email, SMS message or IM message. The recipient user can then access the reply message utilizing the 2-part code, for example, by issuing a “play” command as described above with the 2-part code for the reply message included therein.

A similar two-part code format can be used to specify the media content used in conjunction with a “play” command. In this case, the first part (e.g., <part1>) of the code is the <subscriber ID code> designating the subscriber and the second part (e.g., <part2>) of the code refers to particular media content. The media content may have been previously uploaded to subscriber space on a server or referenced by other means. The association between the two part code and the particular media content is stored in the database 29. The two part code can be used to refer to the media content for subsequent operations carried out by the subscriber. For example, the 2-part code can be forwarded to another user in an email, SMS message or IM message. The recipient user can then access the media content utilizing the 2-part code, for example, by issuing a “play” command as described above with the 2-part code for the media content included therein.

A similar two part code format can also be used to refer to audio status messages recorded by subscribers in conjunction with the “record status” command. In this case, the first part (e.g., <part1>) is the <subscriber ID code> designating the originating subscriber of the audio status message, and the second part (e.g., <part2>) is a system generated code for the audio status message (e.g., “status”). The two part code can be used to refer to the audio status message for subsequent operations carried out by the subscriber. For example, the 2-part code can be forwarded to another user in an email, SMS message or IM message. The recipient user can then access the audio status message, for example, by issuing a “follow” command as described above with the 2-part code for the audio status message included therein.

Unique alphanumeric codes can also be associated with particular communications services. For example, various media files such as podcasts, videos, music, ring tones, etc. can be associated with unique alphanumeric codes that are published to all subscribers, e.g. via one or more web pages. Some of the content may be free to subscribers and other content may be accessed only after a fee is billed to the subscriber's account. Exemplary codes are preferably structured in a logical order to make content easily retrievable by subscribers. For example, “author.title”, “publisher.publication”, “band.song” ordering can be used. These two-part code structures allow for subscriber feedback to the “author”, “publisher”, “band”, etc. The feedback can be provided by addressing a communication (voice call, text, voice mail, etc.) to “author”, “publisher”, “band”, etc. These two-part code structures also allow subscribers to fish for a media file by guessing its name, e.g. “rollingstones.satisfaction” or “tikibar.episode21”. Moreover, codes which are available to a subscriber are searchable.

In yet another aspect of the invention, the codes and tags described herein can have descriptors associated therewith. Such descriptors can be provided by subscribers (or possibly generated by the system in response to a questionnaire or other means). A query interface is provided that enable users to identify tags and codes that relate to descriptors provided as part of a particular query input. The query interface can be provided by a web-accessible interface, a text message command, an IM command, an IVR system or other suitable interface. A user can access the query interface from a mobile phone or other communication device. It is contemplated that subscribers will supply descriptors that self-describe themselves. In this manner, the query interface will enable users to locate and retrieve codes and tags to connect to a person, a pizza store in your area, or anything with a phone in a unique way, and thus provides an enhanced version of a phone book. For example, a search for “pizza sf” may return codes for calling restaurants that delivery pizza in San Francisco. In another example, a search for “hilton hotels new york city” may return codes for calling one or more Hilton hotels in New York City or possibly codes for playing media files associated with Hilton hotels in New York City.

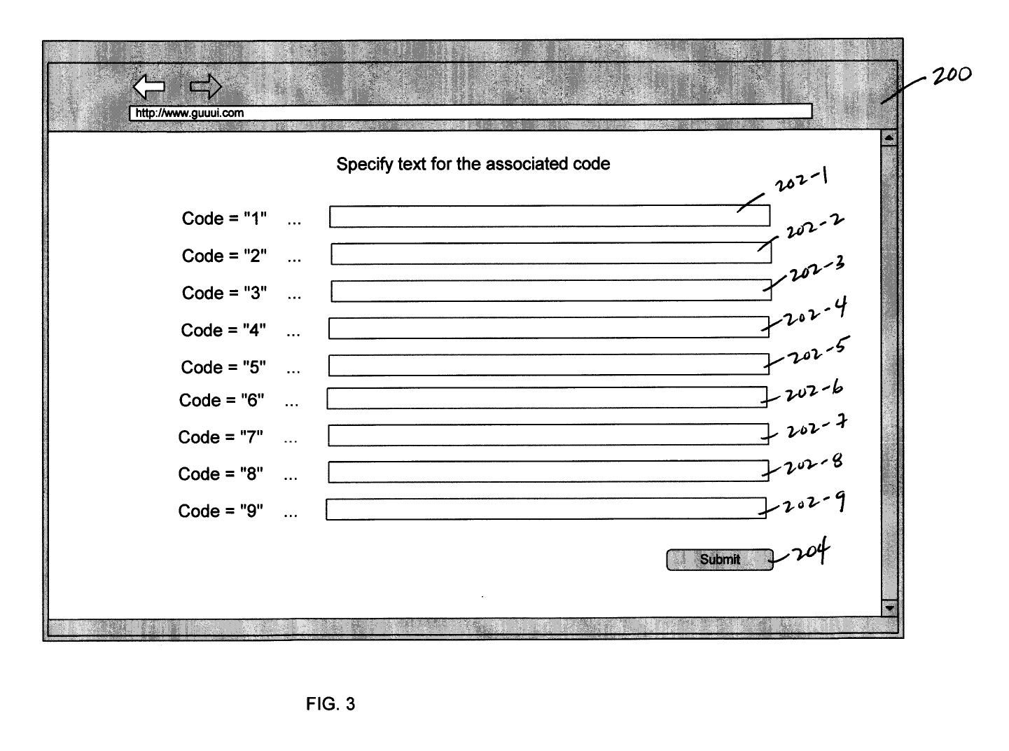

Turning now to FIG. 3, according to an illustrative embodiment of the invention, a graphical user interface (GUI) 200 is provided whereby a subscriber enters arbitrary text that is associated with particular codes. The GUI may be accessed via any communications device which has a graphical display, a pointing device such as a mouse, trackball or stylus, and means for inputting alphanumeric text. Such devices include computers, smart mobile telephones and other wireless devices. Alternatively, a non-GUI connection can be provided. Such interactive connections include IVR with voice recognition or IVR with DTMF input by the subscriber. Subscribers access the service in any conventional way such as by entering a web site. The GUI 200 of FIG. 3 may be selected from a plurality of other GUIs which provide other services.

In the illustrative embodiment, the particular codes of the GUI 200 include one digit numbers in the range from 1 to 9. Text input fields 202-1, 202-2, . . . 202-9 are provided that enable the subscriber to specify arbitrary text that is associated with the corresponding codes. A submit button 204 is provided to submit the specified text for communication to the service. The service stores the arbitrary text specified by the subscriber and the associations between the arbitrary text and the corresponding codes in the database 29. The arbitrary text specified by the subscriber is intended to be text representing any one of the service request messages as discussed herein or any of the service request messages described in the parent applications Ser. Nos. 11/680,291 and 11/550,837, which are incorporated by reference above in there entirety. The subscriber includes any one of these particular codes in a text-based message directed to the service. The service logic 33 is adapted to analyze received text-based messages and identify if any received text-based message specifies any one of the particular codes of GUI 200. In the event that a received text-based message specifies one of the particular codes of GUI 200, the service logic 33 invokes the processing of the text that is stored in the database 29 and corresponds to the particular code. For example, consider an example where a subscriber has specified the text “Call Billyway” for the code “3” as part of the GUI 200, and then texts “3” to the service. In this case, the service logic 33 receives the text message and invokes the processing of “Call Billyway” by the text processing logic 51, which is the text corresponding to the code “3” as stored in the database 29. Such processing invokes the “call” command to the subscriber “Billyway” as described herein. Advantageously, this feature enables a subscriber to quickly and efficiently invoke a number of commands commonly used by the subscriber.

There have been described and illustrated herein several embodiments of systems and methods for delivering communications services. While particular embodiments of the invention have been described, it is not intended that the invention be limited thereto, as it is intended that the invention be as broad in scope as the art will allow and that the specification be read likewise. For example, the peer-to-peer communication operations described herein can be extended to multiple party conferencing. Parties can be added to a multiple-party conference utilizing any suitable mechanism, including dial-in methods to a central service and dial-out methods from the service. For dial-out methods, the text-based message processing described herein can be used to add or join users to the multiparty conference. In the event that a party to a conference call does not accept the call, the system can be adapted to perform one or more tasks, such as i) initiate another call to the party at a designated time (for example, after a 3 minute delay), ii) generate a text-based message to the party with the command and code to join the conference call, or iii) generate a text-based message to the host of the call with the command and code to initiate another attempt to join the party. It will therefore be appreciated by those skilled in the art that yet other modifications could be made to the provided invention without deviating from its spirit and scope as claimed.

What is claimed is:

1. An apparatus for delivering communications services to users comprising:
a service platform for carrying out at least one telecommunication service;
a database storing an association between an alphanumeric code and a particular user, the alphanumeric code uniquely assigned to the particular user;
means for receiving a text-based message from a requesting party, the text-based message including a command field and said alphanumeric code; and
a control block, coupled to said database and said service platform, for controlling said service platform to provide a communications service dictated by said command field and said alphanumeric code included in the received text-based message.

2. An apparatus according to claim 1, wherein:
said text-based message is an SMS-type message.

3. An apparatus according to claim 1, wherein:
said text-based message is an IM-type message.

4. An apparatus according to claim 1, wherein:
said text-based message is an IP-type message.

5. An apparatus according to claim 1, wherein:
the command field of the text-based message includes a first command type that dictates that the service platform connect to the requesting party, connect to a stored telephone number for the particular user associated with the alphanumeric code included in the received text-based message, and bridge the two connections together for voice communication therebetween.

6. An apparatus according to claim 5, wherein:
the service platform communicates with the particular user associated with the alphanumeric code included in the received text-based message to allow for call screening.

7. An apparatus according to claim 6, wherein:
the communication between the service platform and the particular user includes a set of unique codes that allow the particular user to invoke specific functions for the call (e.g., accept the call, block the call, direct the call to voicemail, send a text message to the requester).

8. An apparatus according to claim 1, wherein:
the command field of the text-based message includes a second command type that dictates that the service platform generate and send a text-based message to the particular user associated with the alphanumeric code included in the received text-based message, wherein content of the text-based message sent to the particular user includes content from the received text-based message.

9. An apparatus according to claim 1, wherein:
the command field of the text-based message includes a third command type that dictates that the service platform generate and send text-based messages to a set of recipients, wherein content of the text-based message sent to the set of recipients includes content from the received text-based message.

10. An apparatus according to claim 1, wherein:
the command field of the text-based message includes a fourth command type that dictates that the service platform connect to requesting party, record a voicemail message provided by the requesting party, and store the recorded voicemail message in the mailbox of a particular user associated with the alphanumeric code included in the received text-based message.

11. An apparatus according to claim 10, further comprising:
logic for assigning a unique code to the voicemail message, the unique code referring to the voicemail message for subsequent operations carried out by the particular user (e.g., forwarding the voicemail message, or recording and sending a reply to the voicemail message).

12. An apparatus according to claim 11, wherein:
the unique code assigned to a given voicemail message comprises a two-part code with a first part and a second part, the first part designating the user that generated the voicemail message and the second part being a system generated code for the particular voicemail message.

13. An apparatus according to claim 1, wherein:
the command field of the text-based message includes a fifth command type that dictates that the service platform connect to the requesting party and play or stream media content over the connection to the requesting party.

14. An apparatus according to claim 13, wherein:
the media content is identified by a two-part code having a first part and a second part, the first part designating a particular user and the second part associated with the media content.

15. An apparatus according to claim 1, wherein:
the command field of the text-based message includes a sixth command type that dictates that the service platform connect to the particular user associated with the alphanumeric code included in the received text-based message and record an audio status message provided by the particular user.

16. An apparatus according to claim 15, further comprising:
means for assigning a unique code to the audio status message, the unique code for referring to the audio status message for subsequent operations carried out by one or more users.

17. An apparatus according to claim 16, wherein:
the unique code assigned to a given audio status message comprises a two-part code having a first part and a second part, the first part designating the user that generated the audio status message and the second part being a system generated code.

18. An apparatus according to claim 1, wherein:
the command field of the text-based message includes a seventh command type that supports communication of audio status messages recorded by the service platform.

19. An apparatus according to claim 18, wherein:
in processing the seventh command type, the control block controls to the service platform to connect to the telephone number of the requesting party and play or stream the audio status message specified by the seventh command type over the connection.

20. An apparatus according to claim 1, wherein:
the command field of the text-based message includes an eight command type that supports the sharing of codes stored in the database.

21. An apparatus according to claim 20, wherein:
in processing the eighth command type, the control block controls to the service platform to connect to the telephone number of the requesting party, record an introductory voice message provided by the requesting party, and communicate one or more codes specified by the eight command type and the recorded introductory voice message to a designated user.

22. An apparatus according to claim 1, wherein:
said alphanumeric code is assigned to the particular user by said apparatus.

23. An apparatus according to claim 1, wherein:
said alphanumeric code is assigned based in part on input from the particular user.

24. An apparatus according to claim 1, further comprising:
user interface means for defining the association between the alphanumeric code and the particular user.

25. An apparatus for delivering communications services to users comprising:
a service platform for carrying out at least one communication service;
a database storing an association between a two-part alphanumeric code and one or more content items;
means for receiving a text-based message from a requesting party, the text-based message including said two-part alphanumeric code; and
a control block, coupled to said database and said service platform, for controlling said service platform to provide a communications service that communicates to the requesting party the content items associated with the two-part alphanumeric code included in the received text-based message.

26. An apparatus according to claim 25, wherein:
two-part alphanumeric code identifies particular media content.

27. An apparatus according to claim 26, wherein:
the two-part alphanumeric code comprises a first part and a second part, the first part designating a particular user, and the second part associated with the particular media content.

28. An apparatus according to claim 26, wherein:
the two-part alphanumeric code includes first and second parts that designate one of the following ordered pairs: author and title, publisher and publication, and band and song.

29. An apparatus according to claim 25, wherein:
the two-part alphanumeric code identifies a voicemail message recorded by a particular user.

30. An apparatus according to claim 29, wherein:
the two-part alphanumeric code comprises a first part and a second part, the first part designating the user that generated the voicemail message, and the second part being a system generated code.

31. An apparatus according to claim 25, wherein:
the two-part alphanumeric code identifies an audio status message recorded by a particular user.

32. An apparatus according to claim 31, wherein:
the two-part alphanumeric code comprises a first part and a second part, the first part designating the user that generated the audio status message, and the second part being a system generated code.

33. A method for delivering communications services to users comprising:
storing in a database an association between an alphanumeric code and a particular user, the alphanumeric code uniquely assigned to the particular user;
receiving a text-based message from a requesting party, the text-based message including a command field and said alphanumeric code; and
controlling a service platform to provide a communications service dictated by said command field and said alphanumeric code included in the received text-based message.

34. A method according to claim 33, wherein:
said text-based message is an SMS-type message.

35. A method according to claim 33, wherein:
said text-based message is an IM-type message.

36. A method according to claim 33, wherein:
said text-based message is an IP-type message.

37. A method according to claim 33, wherein:
the command field of the text-based message includes a first command type that dictates that the service platform connect to the requesting party, connect to a stored telephone number for the particular user associated with the alphanumeric code included in the received text-based message, and bridge the two connections together for voice communication therebetween.

38. A method according to claim 39, further comprising:
communicating with the particular user associated with the alphanumeric code included in the received text-based message to allow for call screening.

39. A method according to claim 38, wherein:
the communication with the particular user includes a set of unique codes that allow the particular user to invoke specific functions for the call (e.g., accept the call, block the call, direct the call to voicemail, send a text message to the requester).

40. A method according to claim 33, wherein:
the command field of the text-based message includes a second command type that dictates that the service platform generate and send a text-based message to the particular user associated with the alphanumeric code included in the received text-based message, wherein content of the text-based message sent to the particular user includes content from the received text-based message.

41. A method according to claim 33, wherein:
the command field of the text-based message includes a third command type that dictates that the service platform generate and send text-based messages to a set of recipients, wherein content of the text-based message sent to the set of recipients includes content from the received text-based message.

42. A method according to claim 33, wherein:
the command field of the text-based message includes a fourth command type that dictates that the service platform connect to requesting party, record a voicemail message provided by the requesting party, and store the recorded voicemail message in the mailbox of a particular user associated with the alphanumeric code included in the received text-based message.

43. A method according to claim 42, further comprising:
assigning a unique code to the voicemail message, the unique code referring to the voicemail message for subsequent operations carried out by the particular user (e.g., forwarding the voicemail message, or recording and sending a reply to the voicemail message).

44. A method according to claim 42, wherein:
the unique code assigned to a given voicemail message comprises a two-part code with a first part and a second part, the first part designating the user that generated the voicemail message and the second part being a system generated code for the particular voicemail message.

45. A method according to claim 33, wherein:
the command field of the text-based message includes a fifth command type that dictates that the service platform connect to the requesting party and play or stream media content over the connection to the requesting party.

46. A method according to claim 45, wherein:
the media content is identified by a two-part code having a first part and a second part, the first part designating a particular user and the second part associated with the media content.

47. A method according to claim 33, wherein:
the command field of the text-based message includes a sixth command type that dictates that the service platform connect to the particular user associated with the alphanumeric code included in the received text-based message and record an audio status message provided by the particular user.

48. A method according to claim 47, further comprising:
assigning a unique code to the audio status message, the unique code for referring to the audio status message for subsequent operations carried out by one or more users.

49. A method according to claim 48, wherein:
the unique code assigned to a given audio status message comprises a two-part code having a first part and a second part, the first part designating the user that generated the audio status message and the second part being a system generated code.

50. A method according to claim 33, wherein:
the command field of the text-based message includes a seventh command type that supports communication of audio status messages recorded by the service platform.

51. A method according to claim 50, further comprising:
when processing the seventh command type, controlling the service platform to connect to the telephone number of the requesting party and play or stream the audio status message specified by the seventh command type over the connection.

52. A method according to claim 22, wherein:
the command field of the text-based message includes an eight command type that supports the sharing of codes stored in the database.

53. A method according to claim 52, wherein:
when processing the eighth command type, controlling the service platform to connect to the telephone number of the requesting party, record an introductory voice message provided by the requesting party, and communicate one or more codes specified by the eight command type and the recorded introductory voice message to a designated user.

54. A method according to claim 33, wherein:
said alphanumeric code is assigned to the particular user by said apparatus.

55. A method according to claim 33, wherein:
said alphanumeric code is assigned based in part on input from the particular user.

56. A method according to claim 33, further comprising:
interfacing with the particular user to define the association between the alphanumeric code and the particular user.

57. A method for delivering communications services to users comprising:
storing an association between a two-part alphanumeric code and one or more content items;
receiving a text-based message from a requesting party, the text-based message including said two-part alphanumeric code; and
controlling a service platform to provide a communications service that communicates to the requesting party the content items associated with the two-part alphanumeric code included in the received text-based message.

58. A method according to claim 57, wherein:
two-part alphanumeric code identifies particular media content.

59. A method according to claim 58, wherein:
the two-part alphanumeric code comprises a first part and a second part, the first part designating a particular user, and the second part associated with the particular media content.

60. A method according to claim 57, wherein:
the two-part alphanumeric code includes first and second parts that designate one of the following ordered pairs: author and title, publisher and publication, and band and song.

61. A method according to claim 60, wherein:
the two-part alphanumeric code identifies a voicemail message recorded by a particular user.

62. A method according to claim 61, wherein:
the two-part alphanumeric code comprises a first part and a second part, the first part designating the user that generated the voicemail message, and the second part being a system generated code.

63. A method according to claim 57, wherein:
the two-part alphanumeric code identifies an audio status message recorded by a particular user.

64. A method according to claim 63, wherein:
the two-part alphanumeric code comprises a first part and a second part, the first part designating the user that generated the audio status message, and the second part being a system generated code.
